(19) United States
(12) Patent Application Publication
(10) Pub. No.: US 2018/0192182 A1
(43) Pub. Date: Jul. 5, 2018

(54) ANTI-SEPARATION EARPHONE ASSEMBLY

(71) Applicants: Fu Tai Hua Industry (Shenzhen) Co., Ltd., Shenzhen (CN); HON HAI PRECISION INDUSTRY CO., LTD., New Taipei (TW)

(72) Inventors: XIN YANG, Shenzhen (CN); CHIEH-YU LEE, New Taipei (TW)

(21) Appl. No.: 15/688,866

(22) Filed: Aug. 29, 2017

(30) Foreign Application Priority Data
Dec. 30, 2016 (CN) 201611261340.5

(51) Int. Cl. H04R 1/10; H01R 13/625

(52) U.S. Cl. CPC H04R 1/1091; H01R 13/625

(57) ABSTRACT

An anti-separation earphone assembly includes an anti-separation earphone connector and an anti-separation earphone connector interface. The anti-separation earphone connector is received in and rotationally secured in the anti-separation earphone connector interface.

### CROSS-REFERENCE TO RELATED APPLICATIONS

This application claims priority to Chinese Patent Application No. 201611261340.5 filed on Dec. 30, 2016, the contents of which are incorporated by reference herein.

### FIELD

The subject matter herein generally relates to earphones, and more particularly to an anti-separation earphone assembly for preventing an electronic device from dropping while still attached to the earphone assembly.

### BACKGROUND

Generally, earphones are connected to an electronic device through an audio jack of the electronic device. Sometimes, the electronic device may be dropped accidentally while being plugged in by the earphones, which causes the earphones to violently disengage or separate from the audio jack.

### BRIEF DESCRIPTION OF THE DRAWINGS

Implementations of the present technology will now be described, by way of example only, with reference to the attached figures.

FIG. 1 is an assembled isometric view of an anti-separation earphone assembly.

FIG. 2 is an exploded view of the anti-separation earphone assembly of FIG. 1.

FIG. 3 is a cross-sectional view taken along line III-III of FIG. 2.

FIG. 4 is a cross-sectional view taken along line IV-IV of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

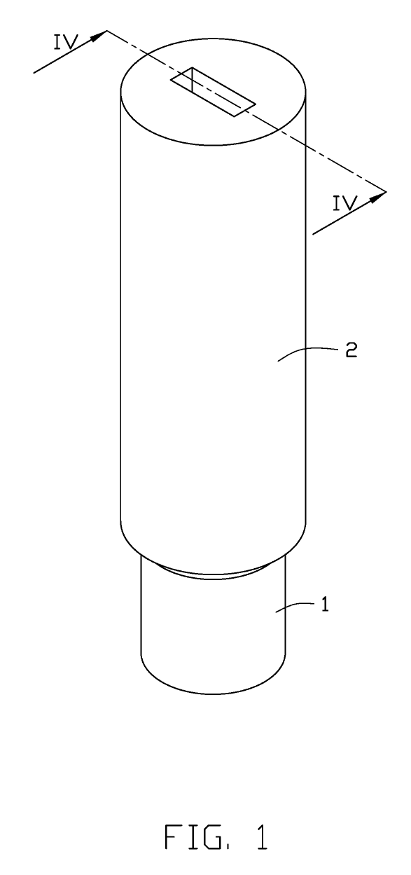

FIG. 1 illustrates an embodiment of an anti-separation earphone assembly, which includes an anti-separation earphone connector 1 and an anti-separation earphone connector interface 2. The anti-separation earphone connector interface 2 can be installed beforehand in an electronic device for receiving the anti-separation earphone connector 1.

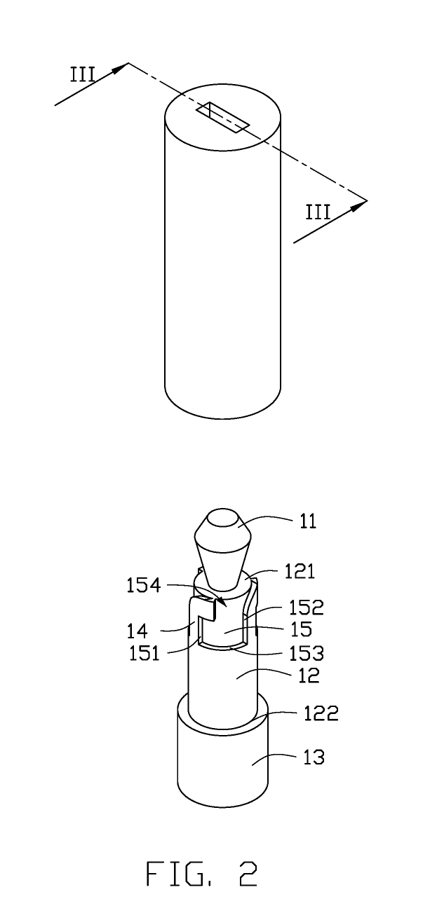

FIG. 2 is an exploded view of FIG. 1. The anti-separation earphone connector 1 may include a first connector 11, a second connector 12, and a third connector 13. The second connector 12 includes a first end 121 and a second end 122. The first end 121 of the second connector 12 is coupled to the first connector 11, and the second end 122 of the second connector 12 is coupled to the third connector 13. As illustrated in this embodiment, the anti-separation earphone connector 1 can include three connectors. In other embodiments, the anti-separation earphone connector 1 can include more or less than three connectors.

An outer periphery of the second connector 12 defines a groove 15. In detail, the groove 15 is defined from the first end 121 of the second connector 12 and extends toward the second end 122. The groove includes a first wall 151, a second wall 152, and a third wall 153. The third wall 153 is coupled between the first wall 151 and the second wall 152. A stop part 14 extends from the first wall 121 toward the second wall 122. An edge of the stop part 14 adjacent to the first wall 121 forms a step. An opening 154 of the groove 15 is between the stop part 14 and the second wall 152. In at least one embodiment, the second wall 152 is arcuate. In at least one embodiment, there are two stop parts 14 and two grooves 15. Each stop part 14 is paired with a corresponding groove 15 on the second connector 12.

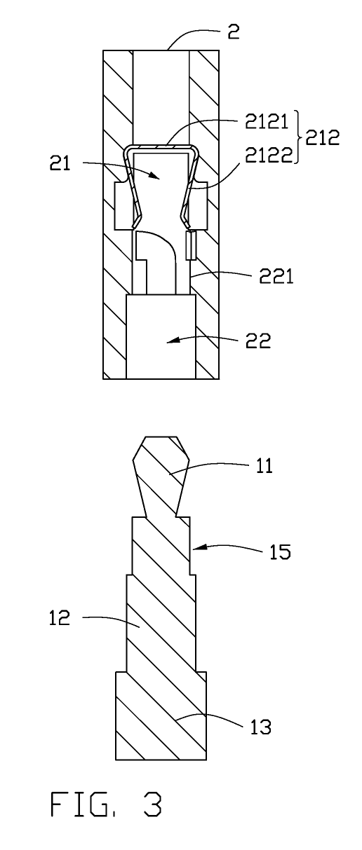

FIG. 3 is a cross-sectional view of FIG. 2 taken along line III-III. The anti-separation earphone connector interface 2 includes a first coupling hole 21 and a second coupling hole 22. The first coupling hole 21 and the second coupling hole 22 are coaxial with each other. The first coupling hole 21 is used for receiving the first connector 11 of the anti-separation earphone connector 1. The second coupling hole 22 is used for receiving the second connector 12 of the anti-separation earphone connector 1. Protrusions 221 are formed on an inner surface of the second coupling hole 22. The protrusions 221 are used for resisting against the stop parts 14 to secure the anti-separation earphone connector 1 in the anti-separation earphone connector interface 2. In at least one embodiment, the number of the protrusions 221 is equal to the number of the stop parts 14.

In at least one embodiment, an elastic piece 212 is located at an end of the first coupling hole 21 away from the second coupling hole 22. The elastic piece 212 is used for electrically coupling with the first connector 11. In detail, the elastic piece 212 includes a coupling portion 2121 and two clamping portions 2122. Each clamping portion 2122 is coupled to a corresponding end of the coupling portion 2121. A junction between the coupling portion 2121 and each clamping portion 2122 defines an acute angle. As a result, a width between the two clamping portions 2122 decreases from a junction with the coupling portion 2121 to an end of the clamping portions 2122.

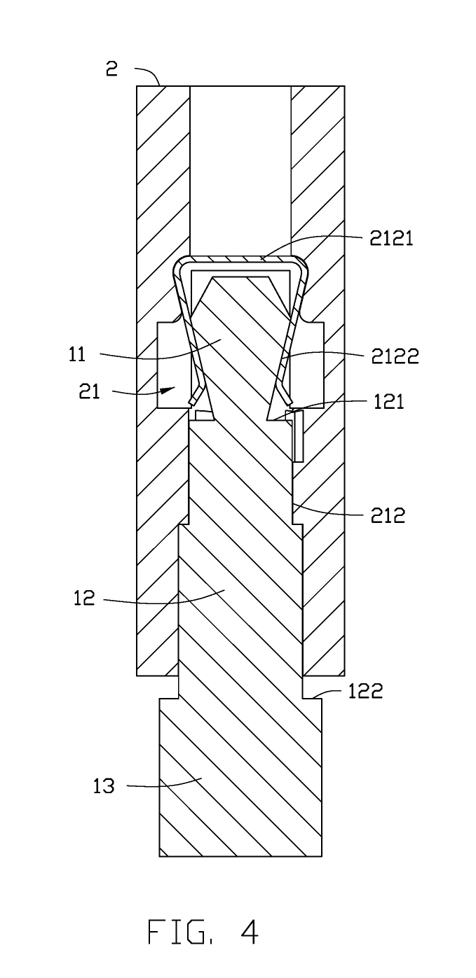

FIG. 4 is a cross-sectional view of FIG. 1 taken along line IV-IV. When the anti-separation earphone connector 1 is inserted into the anti-separation earphone connector interface 2, a restoring force of the clamping portions 2122 of the elastic piece 212 biases the anti-separation earphone connector 1 to rotate along a first predetermined direction. In detail, the stop part 14 is rotated by the restoring force to a position where the protrusion 221 of the anti-separation earphone connector interface 2 resists against the step of the stop part 14, thereby securing the second connector 12 of the anti-separation earphone connector 1.

When the anti-separation earphone connector 1 is rotated along a second predetermined direction opposite to the first predetermined direction, the stop part 14 is disengaged from the protrusion 221, and the anti-separation earphone connector 1 can be removed from the anti-separation earphone connector interface 2.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An anti-separation earphone assembly comprising:
an anti-separation earphone connector; and
an anti-separation earphone connector interface;
wherein the anti-separation earphone connector is received in and rotationally secured in the anti-separation earphone connector interface.

2. The anti-separation earphone assembly of claim 1, wherein the anti-separation earphone connector comprises:
a first connector;
a second connector; and
a third connector;
wherein the second connector comprises a first end and a second end, the first end coupled to the first connector, the second end coupled to the third connector;
wherein a groove is defined in an outer periphery of the second connector, the groove extending from the first end toward the second end;
wherein the groove comprises a first wall, a second wall, and a third wall, the third wall being coupled between the first wall and the second wall;
wherein the first wall comprises a stop part, the stop part extending from the first wall toward the second wall;
wherein an edge of the stop part adjacent to the first wall forms a step;
wherein an opening is defined between the stop part and the second wall, the opening communicating with the groove.

3. The anti-separation earphone assembly of claim 2, wherein the second wall is arcuate.

4. The anti-separation earphone assembly of claim 3, wherein the anti-separation earphone connector interface defines a first coupling hole and a second coupling hole therein, the first coupling hole being coaxial with the second coupling hole, the first coupling hole receiving the first connector, and the second coupling hole receiving the second connector.

5. The anti-separation earphone assembly of claim 4, wherein the anti-separation earphone connector interface comprises a protrusion formed in the second coupling hole, wherein the protrusion resists against the stop part of the second connector.

6. The anti-separation earphone assembly of claim 5, wherein the anti-separation earphone connector interface further comprises an elastic member located at an end of the first coupling hole away from the second coupling hole, the elastic member configured to be electrically coupled to the first connector.

7. The anti-separation earphone assembly of claim 6, wherein the elastic member comprises a coupling portion and two clamping portions, the coupling portion being coupled between the two clamping portions, a junction between the coupling portion and each clamping portion defining an acute angle.

8. The anti-separation earphone assembly of claim 7, wherein when the anti-separation earphone connector is inserted into the anti-separation earphone connector interface, a restoring force of the clamping portions of the elastic piece biases the anti-separation earphone connector to rotate along a first predetermined direction, thereby rotating the stop part to a position where the protrusion of the anti-separation earphone connector interface resists against the step of the stop part, thereby securing the second connector of the anti-separation earphone connector.

9. The anti-separation earphone assembly of claim 8, wherein when the anti-separation earphone connector is rotated along a second predetermined direction opposite to the first predetermined direction, the stop part is disengaged from the protrusion, and the anti-separation earphone connector can be removed from the anti-separation earphone connector interface.

10. An anti-separation earphone connector configured to be inserted into an anti-separation earphone connector interface, the anti-separation earphone connector comprising:
a first connector received in an anti-separation earphone connector interface;
a second connector received in the anti-separation earphone connector interface; and
a third connector;
wherein the second connector comprises a first end and a second end, the first end coupled to the first connector, the second end coupled to the third connector;
wherein a groove is defined in an outer periphery of the second connector, the groove extending from the first end toward the second end;
wherein the groove comprises a first wall, a second wall, and a third wall, the third wall being coupled between the first wall and the second wall;
wherein the first wall comprises a stop part, the stop part extending from the first wall toward the second wall and configured to resist against a protrusion of the anti-separation earphone connector interface;
wherein an edge of the stop part adjacent to the first wall forms a step;
wherein an opening is defined between the stop part and the second wall, the opening communicating with the groove.

11. The anti-separation earphone connector of claim 10, wherein the second wall is arcuate.

12. The anti-separation earphone assembly of claim 11, wherein when the anti-separation earphone connector is inserted into the anti-separation earphone connector interface, the anti-separation earphone connector is biased to rotate along a first predetermined direction, thereby rotating the stop part to a position where the protrusion of the anti-separation earphone connector interface resists against the step of the stop part, thereby securing the second connector of the anti-separation earphone connector.

13. The anti-separation earphone assembly of claim 12, wherein when the anti-separation earphone connector is rotated along a second predetermined direction opposite to the first predetermined direction, the stop part is disengaged from the protrusion, and the anti-separation earphone connector can be removed from the anti-separation earphone connector interface.

14. An anti-separation earphone connector interface configured for receiving an anti-separation earphone connector, wherein:
wherein the anti-separation earphone connector interface defines a first coupling hole and a second coupling hole therein, the first coupling hole being coaxial with the second coupling hole, the first coupling hole and the second coupling hole receiving the anti-separation earphone connector therein.

15. The anti-separation earphone connector interface of claim 14, wherein the anti-separation earphone connector interface comprises a protrusion formed in the second coupling hole, wherein the protrusion resists against a stop part of the anti-separation earphone connector.

16. The anti-separation earphone connector interface of claim 15, wherein the anti-separation earphone connector interface further comprises an elastic member located at an end of the first coupling hole away from the second coupling hole, the elastic member configured to be electrically coupled to the first connector.

17. The anti-separation earphone assembly of claim 16, wherein the elastic member comprises a coupling portion and two clamping portions, the coupling portion being coupled between the two clamping portions, a junction between the coupling portion and each clamping portion defining an acute angle.

18. The anti-separation earphone assembly of claim 17, wherein when the anti-separation earphone connector is inserted into the anti-separation earphone connector interface, a restoring force of the clamping portions of the elastic piece biases the anti-separation earphone connector to rotate along a first predetermined direction, thereby rotating the stop part to a position where the protrusion of the anti-separation earphone connector interface resists against a step of the stop part, thereby securing the second connector of the anti-separation earphone connector.

19. The anti-separation earphone assembly of claim 18, wherein when the anti-separation earphone connector is rotated along a second predetermined direction opposite to the first predetermined direction, the stop part is disengaged from the protrusion, and the anti-separation earphone connector can be removed from the anti-separation earphone connector interface.
